(19) United States
(12) Patent Application Publication
(10) Pub. No.: US 2014/0272893 A1
(43) Pub. Date: Sep. 18, 2014

(54) COLLABORATIVE ASYNCHRONOUS ONLINE LEARNING

(71) Applicant: Edison Learning Inc., Pittsburgh, PA (US)

(72) Inventors: Raymond ROZYCKI, McDonald, PA (US); David ZEILER, Pittsburgh, PA (US); Joshua MACK, Pittsburgh, PA (US)

(73) Assignee: Edison Learning Inc., Pittsburgh, PA (US)

(21) Appl. No.: 14/202,089

(22) Filed: Mar. 10, 2014

Related U.S. Application Data
(60) Provisional application No. 61/794,957, filed on Mar. 15, 2013.

(51) Int. Cl. G09B 5/00

(52) U.S. Cl. CPC G09B 5/00
USPC 434/350

(57) ABSTRACT

A system and method of e-learning involving an online asynchronous interdisciplinary project-based curriculum where students are provided with learning content relating to an interdisciplinary project and complete role-based tasks relating to the project. The students work collaboratively to complete the project thereby developing core learning skills that foster the growth of each student's social communication skills.

### CROSS REFERENCE TO RELATED APPLICATIONS

The present application claims benefit to the filing date of Provisional Application No. 61/794957, filed on Mar. 15, 2013.

### TECHNICAL FIELD OF THE INVENTION

The present invention relates to e-learning systems and methods where students asynchronously work collaboratively on projects to fulfill educational objectives. More specifically, students work over a period of time on an interdisciplinary project that, for example, encompasses four main subject areas. Each student chooses a role and progresses through the work at their own pace. The students are given core learning skills that are used to drive the group interaction and comments. Students complete self-evaluation and peer-evaluation of the mastery of the core learning skills as part of the collaborative project.

### BACKGROUND OF THE INVENTION

E-learning is an inclusive term that describes educational technology that electronically or technologically supports learning and teaching. E-learning includes numerous types of media that deliver text, audio, images, animation and video through technology applications and processes such as computers, local intranet/extranet and the Internet. E-learning can occur in or out of the classroom. It can be self-paced, asynchronous learning or may be instructor-led, synchronous learning. E-learning is suited to distance learning and flexible learning, but it can also be used in conjunction with face-to-face teaching, in which case the term blended learning is commonly used.

Computer-based learning or training (CBT) refers to self-paced learning activities delivered on a computer or handheld device such as a tablet or smartphone. CBT often presents content in a linear fashion, much like reading an online book or manual. Assessing learning in a CBT is often by assessments that can be easily scored by a computer such as multiple choice questions, drag-and-drop, radio button, simulation or other interactive interfaces. Assessments are easily scored and recorded via software, providing immediate end-user feedback and completion status. CBTs provide learning stimulus beyond traditional learning methodology from textbook, manual, or classroom-based instruction. For example, CBTs offer user-friendly solutions for satisfying continuing education requirements. Instead of limiting students to attending courses or reading printed manuals, students are able to acquire knowledge and skills through methods that are much more conducive to individual learning preferences. For example, CBTs offer visual learning benefits through animation or video, not typically offered by any other means. CBTs can be a good alternative to printed learning materials since rich media, including videos or animations, can easily be embedded to enhance the learning. CBTs pose some learning challenges. Typically, the creation of effective CBTs requires enormous resources. The software for developing CBTs is often more complex than a subject matter expert or teacher is able to use.

Computer-supported collaborative learning (CSCL) uses instructional methods designed to encourage or require students to work together on learning tasks. Collaborative learning is distinguishable from the traditional approach to instruction in which the instructor is the principal source of knowledge and skills. In contrast to the linear delivery of content, often directly from the instructor's material, CSCL uses blogs, wikis, and cloud-based document portals. With technological Web 2.0 advances, sharing information between multiple people in a network has become much easier and use has increased. Using CSCL social tools in the classroom allows for students and teachers to work collaboratively, discuss ideas, and promote information. After initial instruction on using the tools, students may report an increase in knowledge and comfort level for using CSCL tools. The collaborative tools also prepare students with technology skills necessary in today's workforce.

One of the strengths of CBT and CSCL, the ability for self-paced learning by individuals, also creates significant drawbacks in that it limits the ability for students in developing core learning skills, such as inter-personal skills and the ability to interact in completing work in a collaborative environment.

It is with respect to these considerations and others that the present invention has been made.

### SUMMARY OF THE INVENTION

The present invention provides students with an environment conducive to development of skills relating to collaborative learning. Students work on an interdisciplinary project either at their own pace and/or together with other students. The project encompasses, for example, four main subject areas (math, ELA, science, social studies) that are worked on over a period of time. Within the project, each student picks a role that they want to do and then are given tasks that are related to that role for that specific week. In another aspect of the invention, as the student progresses through the weeks, the student may pick a different role each time, giving them a different view on the questions received. The student may play each role prior to the conclusion of the project. Throughout the time period for the project, students are paired up with other students that are in the same place in the curriculum. The students are able to progress and work with other group members on the project either synchronously or, alternatively, asynchronously (but collaboratively) at their own pace.

The students may be given core learning skills in the form of a series of “I can . . . ” statements that help drive the group interaction and comments, and provide the basis for evaluation of the development of core learning skills for collaborative work. In another aspect of the invention, students may complete self-evaluation and peer-evaluation of the mastery obtained relating to these “I can . . . ” statements. Students may have the ability to chat with their other teammates, as well as comment and discuss their work with one another. This collaboration allows students to produce one theme-based project over the course of the time period.

### BRIEF DESCRIPTION OF THE DRAWINGS

The figures are for illustration purposes only. However, the invention itself may best be understood by reference to the detailed description which follows when taken in conjunction with the accompanying drawings in which:

FIG. 1 shows a flow chart for one embodiment of the present invention;

FIG. 2 depicts an exemplary screen presentation for an access portal to the present invention;

FIG. 3 depicts an activities window for a student in one embodiment of the present invention;

FIG. 4 shows a screen where content is being displayed to a student in one embodiment of the present invention;

FIG. 5 shows a window for rewriting core learning skills in one embodiment of the present invention;

FIGS. 6 depicts one example of a window showing essay question for students for one embodiment of the present invention;

FIGS. 7 and 8 are windows providing for self-evaluation and peer-evaluation for students in one embodiment of the present invention;

FIG. 9 shows the real-time collaboration by students within the activities window in one embodiment of the present invention; and

FIG. 10 shows the window for providing assistance to students in one embodiment of the present invention.

### DETAILED DESCRIPTION OF THE INVENTION

Various embodiments will now be described with reference to the accompanying drawings, which form a part of the description, and which show, by way of illustration, specific embodiments. However, this invention may be embodied in many different forms and should not be construed as limited to the specific embodiments set forth herein. Rather, these embodiments are provided so that this disclosure will be thorough and complete, and will fully convey the scope of the invention to those skilled in the art. As described below, various embodiments of the invention may be readily combined without departing from the scope or spirit of the invention.

The term “interdisciplinary project” is a problem or undertaking divided into multiple tasks performed by two or more students where the students' work product are typically combined into a finished product. The term “subject-based roles” is defined as a position, character or actor that has a particular viewpoint with respect to the learning content for the interdisciplinary project. As an example, the subject-based roles may be a historian, a mathematician, a scientist or a journalist. The term “core—learning skills” are the basic aptitude or ability of the students that are dependent on the student's grade and level of progress. Typically, the core—learning skills of the present invention relate directly to the ability to work and interact with others in performing the interdisciplinary project.

The students begin with an activities checklist, presented within the application after the students log in to the system. This checklist serves as an easy-to-follow guide to the tasks to be accomplished that day. The checklist includes subject areas; the learning objectives that need to be completed for each lesson; and any team activity tasks that must be completed. The team-based aspect of the curriculum allows students to experiment with and develop learned social communication in an educational environment. The tools that students use include the chat feature and the ability to comment on the work of others. This component is built around the core learning skills, which in one example are a set of “I can . . . ” statements designed to foster the growth of each student's social communication skills.

The invention may be typically implemented through software running on a computer. The computer may be any type of client device, including desktop computers, laptop computers, tablet computers, cell phones and any other device. The computer may be capable of establishing a communications link with the Internet, local area network or a wide area network through either a wired medium or wireless medium, and the computer may run an application program enabling the device to perform the programmed algorithms. The application for performing the algorithms of the invention as described below may be implemented on a standalone computer, or maybe implemented through several computers connected via a network. In one embodiment, the algorithms of the invention may be implemented on a central server, where the students access the system through remotely located client devices. In another embodiment, the central server operates in conjunction with a remote network device to perform the recited steps or constitutes the system. The steps or apparatus may be performed at either the server, the remote network device or through a combination of the two. The application programs are stored in physical memory devices, such as RAM, ROM, hard-drives, optical drives and any other non-volatile memory device. The client devices may include application programs that send and receive web-pages, web-based messages, and data packets having content for updating the program and display of the client devices. The client devices may have operating systems that enable the application programs.

Various aspects of the invention can be implemented in several different ways. For example, the invention can be implemented through a traditional client server arrangement or a peer-to-peer network architecture. The application program can be implemented in client devices, network-devices or any combination of various devices. The client devices may run a thin-client application program. In one embodiment, the client application program may be executed through a web browser. The client application may be a browser plug-in that is activated on execution of the browser program or activated at a later time.

The general process flow of the online asynchronous interdisciplinary project-based curriculum is shown in FIG. 1. In block 102, students are enrolled in an interdisciplinary project or collaborative activity. The interdisciplinary projects are structured to measure each student's growth regarding core learning skills and to apply the students' understanding of the material in a course over a period of time. The curriculum presents a different theme for each time period, which is typically a nine-week course. Typically, the theme forms the basis of all activities and tasks for the period. However, there may be more than one theme and/or the themes may overlap between courses. As an example, the curriculum may present seven theme-related topics per nine weeks, and each week students have the opportunity to choose their roles within the team. As examples, the interdisciplinary projects may include topics such as Lewis & Clark, Treasure Hunt, Medieval Times, Olympics, Black Bart's Voyage, Apollo 11, Medici Influence or Human Rights.

After enrollment, the student choses a subject-based role within the interdisciplinary project shown by block 104. In one embodiment, within each time period, each student may be required to choose each role at least once in every subject in which he or she is enrolled. As example, the student could choose one of four roles in the team projects such as a mathematician, journalist, historian, or scientist. The following week, the student would be required to choose a different one of the four roles. After choosing a role within the team, the first week of activities is unlocked at block 106 and the student receives a list of the weekly objectives, the core learning skills to be emphasized, and the tasks to be completed as shown in block 108. The students interact throughout each week of the project using the chat and comment features as well as messaging with other students in their group. Some tasks that the students are assigned require the student to discuss and work with other teammates to complete. The students are delivered appropriate theme and topic videos depending on which role and week they are currently on. The ability the chat via microphone may make group work much better for students that are online together at the same time. The students may also have the ability to upload images, videos or other materials use for completing the project or sharing with their teammates. The collaboration between students may occur at the same time or may occur asynchronously. Any method of real-time and/or asynchronous communication is contemplated, including but not limited to e-mail, messaging, teleconference, videoconference, file sharing and similar electronic communications.

In block 114, as each student completes the weekly activities, his or her work is saved and in one embodiment compiled with that of teammates. Alternatively, the work product may be compiled at the end of the project. The students may then complete self-evaluations and/or peer-evaluations of each other based on a mastery of the core learning skills as shown in block 116. On completion of the evaluations in block 118, the weekly activities for the following week may be unlocked. Once all of the tasks for the period are completed, the student may receive a final grade and the project is placed in their portfolio in block 122.

If the student has difficulty, questions or requires assistance during the course of the project, help can be provided by either the teacher or through external support such as links, videos, hints, and/or the previous weeks answer key as shown in box 110 and 112. The teacher may also review the work, both individually and collectively, and provide feedback on any particular session as provided in block 120.

In one embodiment, the content for the program may be changed as can the roles selected by the students, but the structure of the environment itself may stay the same. This tool could also be used for students of any age or grade level.

An example of a more specific implementation of the online asynchronous interdisciplinary or collaborative project-based curriculum is shown in FIGS. 2 through 10, which show the computer screen displays presented to the students in implementing the present invention. FIG. 2 shows portal 200 to the online asynchronous interdisciplinary project-based curriculum. In one embodiment, access by the student may be through a Web-based browser that accesses a server hosting the application program.

In starting the collaborative project, the student is first shown an introductory window 202 that asks the student to select a role as shown in window 204. In this instance, the student is asked to choose between historian 206, mathematician 208, scientist 210 and journalist to 212. The roles chosen by the student will determine the content of the program that is presented to the student.

After selecting a role, the student is shown activities window 302 in FIG. 3. Activities window 302 may be in a binder-like presentation that contains summary information about the project. For example, title 304 may be displayed showing the title of the current project, and progress bar 306 may show the individual's progress and the group's progress as a function of percentage completion. Role 308 that student is currently playing may be highlighted in some fashion, and selecting the other roles may show summary information for the other students. The student may also view profile 314 which will show profile information for the student, engage in chat by clicking on chat tab 316 or review the core learning skills by clicking on tab 318. As an example, under the profile tab, there may be a status indicator 320 to indicate whether the user is online or not, it may display grade 322 for the student, which shows the students grade level, and may also list information such as student's school and identification information. Activities window 302 may also show activities list 310 that show the various activities that the student should engage in for the current time period, which is typically a day or a week. Activities may be individually listed as shown by call outs 312 and, as the activities are completed, a checkmark may appear in checkbox 328. When the user has completed reviewing activities window 302, the student may press done button 324.

The activities for the week constitute such things as watching a team video that provides overall review of the course material for the project, review the topic video which is a sub-topic of the theme that is applicable for the current week, write or rewrite core learning skills, respond to essay/bar/line/pie/graph question types, complete a self-evaluation and complete a peer-evaluation.

An example of being video is shown is theme video window 402 in FIG. 4. In this particular instance, the theme video provides an overview of the Lewis and Clark expedition where a teacher may convey the information for the lesson learned in any of various matters, such as through an oral presentation, using graphics 404, animations or any other methods of communicating concepts and ideas. The video may be controlled through the use of control bar 406, and may be played multiple times by the student.

An example of rewriting core learning skills is shown in FIG. 5. The core learning skills may be preset as shown by call out 504. In this particular example, the core learning skills are: whether the student can accept constructive feedback about their contribution from their peers and others, and act on it; the student can identify what further information is needed to solve a problem and/or break complex problems down into a series of tasks; and the student can plan what specific research questions require answering to solve a given problem. The student may rewrite each of the core learning skills in entry space 506. When completed, the user submits their re-written core learning skills be selecting submit button 508.

In FIG. 6, an example of an essay question is provided in window 602. Question 604 is presented to the student. The student's response may be entered by the student in answer space 606. In one embodiment, the student is provided with the ability to search the Internet by entering search terms into entry space 608 and then pressing Web search button 610. The student may also provide comments on the question in space 612 and when the student has finished answering the question and inserted any desired comments, the student may select submit button 614. Any other type of questions may be presented to the student. Examples of such other types of questions include bar graph questions, line graph questions, pie chart questions, multiple choice or fill-in the blank.

After completion of the material for each week, the student may be required to complete a self-evaluation as shown in FIG. 7. This is where the student will rate themselves on how well they believe they have learned the core learning skills. In one embodiment, the user will use position slider 706 to indicate how well they believe they have learned the new skill. The student may also enter an explanation in space 708 relating to the self-evaluation. In one instance, the slider is capable of moving in increments from one extreme to the other. In another embodiment, the slider may indicate a percentage of learning or any other indication of how well the student has learned the new skill. When the student has completed their self-evaluation, the student presses submit rating button 710 to submit the evaluation.

Next, the student may be required to complete peer evaluation 802 as shown in FIG. 8. The student rates their peers who have taken on other roles within the collaborative project on how they have met the core-learning skills. The process is the same as that for the self-evaluation.

The user may be able communicate with other students that are playing other roles through chat window 902 is shown in FIG. 9. The amount of required collaboration may be varied depending upon the required core learning skills. Chat window 902 may be real-time between the two students, but may also be asynchronous such that both students to not need to be online at the same time.

If the student requires assistance, the student may press help button 1004, which brings up help screen 1002 in FIG. 10. Help screen 1002 may contain a hint or links to tutorial videos 1004, user guide 1046 or a link enabling the student to contact the teacher through ask teacher link 1008.

Although other modifications and changes may be suggested by those skilled in the art, it is the intention of the inventors to embody within the patent warranted hereon all changes and modifications that reasonably and properly come within the scope of their contribution to the art.

What is claimed is:

1. A system for enabling students to collaborate in an on-line e-learning environment comprising:
a server having access to a database containing an e-learning interdisciplinary project stored in non-volatile memory;
a network device having a display that is in communication with the server and in conjunction with the server having computer executable instructions stored in a memory device that enable steps including:
assigning subject-based roles to two or more students within the interdisciplinary project;
displaying learning content relating to the interdisciplinary project on the display of the network device;
associating interrelated interdisciplinary project tasks with each of the two or more students, where the tasks relate to each of the assigned subject-based roles;
enabling the two or more students to interact asynchronously in an on-line environment in completing the interdisciplinary project tasks;
evaluating core-learning skills relating to interactions between the students in completing the interdisciplinary project tasks; and
compiling the completed tasks from the two or more students to produce a completed interdisciplinary project.

2. The system of claim 1 wherein the evaluating of the core-learning skills relating to the students' interactions in completing the interdisciplinary project tasks is a self-evaluation.

3. The system of claim 1 wherein the evaluating of the core-learning skills relating to the students' interactions in completing the interdisciplinary project tasks is a peer-evaluation.

4. The system of claim 1, where the network device in conjunction with the server has further executable instructions that enable steps including:
enabling the students to re-write the core learning skills; and
the evaluating of the core-learning skills relating to the students' interactions in completing the interdisciplinary project tasks is based on the re-written core learning skills.

5. The system of claim 1 wherein each student is assigned each subject-based role during the course of completion of the interdisciplinary project.

6. The system of claim 1, where the network device has further executable instructions that enable steps including:
the interdisciplinary project tasks are grouped in time periods; and
interdisciplinary project tasks for the next time period are unlocked for the students to work on only after completion of the evaluation of the core-learning skills relating to the students' interactions in completing the interdisciplinary project tasks for the current time period.

7. The system of claim 1, where the network device has further executable instructions that enable steps including:
tracking progress of completing the interdisciplinary project; and
displaying the progress of completion of the interdisciplinary project to the students.

8. A method of enabling students to collaborate in an e-learning on-line environment comprising:
enrolling two or more students in a joint e-learning interdisciplinary project through the use of networked computers;
assigning each of the two or more students a subject-based role within the interdisciplinary project;
presenting each of the two or more students with learning content relating to the interdisciplinary project on a display of the networked computer;
assigning interdisciplinary project tasks to the two or more students tailored to each of the assigned subject-based roles;
enabling the two or more students to interact asynchronously in an on-line environment in completing the interdisciplinary project tasks;
evaluating core-learning skills relating to the students' interactions in completing the interdisciplinary project tasks; and
consolidating automatically the completed tasks from the two or more students to produce a completed interdisciplinary project.

9. The method of claim 8 wherein the evaluating of the core-learning skills relating to the students' interactions in completing the interdisciplinary project tasks is a self-evaluation.

10. The method of claim 8 wherein the evaluating of the core-learning skills relating to the students' interactions in completing the interdisciplinary project tasks is a peer-evaluation.

11. The method of claim 8 further comprising:
enabling the students to re-write the core learning skills; and
the evaluating of the core-learning skills relating to the students' interactions in completing the interdisciplinary project tasks is based on the re-written core learning skills.

12. The method of claim 8 wherein each student is assigned each subject-based role during the course of completion of the interdisciplinary project.

13. The method of claim 8 further comprising:
the interdisciplinary project tasks are grouped in time periods; and
interdisciplinary project tasks for the next time period are unlocked for the students to work on only after completion of the evaluation of the core-learning skills relating to the students' interactions in completing the interdisciplinary project tasks for the current time period.

14. The method of claim 8 further comprising:
tracking progress of completing the interdisciplinary project; and
displaying the progress of completion of the interdisciplinary project to the students.

15. A computer apparatus having a processor, memory and display, whether the apparatus permits on-line collaboration of students in an e-learning course comprising:
an interdisciplinary project stored in the memory;
two or more subject-based roles, each of which are assigned to a student, where the subject-based roles relate to the interdisciplinary project;
learning content stored in the memory relating to the interdisciplinary project that is provided to the students on the display of the apparatus;
subject-based role tasks relating to the learning content that are provided to the students periodically to complete the interdisciplinary project;
means for asynchronous collaboration between students to complete the subject-based role tasks;
a set of core learning skills relating to collaboration between students on the interdisciplinary project that are evaluated after completion of work on the subject-based role tasks;
wherein the work on the subject-based role tasks are combined together to form a complete interdisciplinary project.

16. The apparatus of claim 15 wherein the evaluating of the core-learning skills is a self-evaluation.

17. The apparatus of claim 15 wherein the evaluating of the core-learning skills is a peer-evaluation.

18. The apparatus of claim 15, where the apparatus further includes:
a means for the students to re-write the core learning skills; and
wherein the evaluating of the core-learning skills is based on the re-written core learning skills.

19. The apparatus of claim 15 wherein each student is assigned each subject-based role during the course of completion of the interdisciplinary project.

20. The apparatus of claim 15, where the apparatus further includes:
wherein the subject-based role tasks are grouped in time periods; and
wherein the subject-based role tasks for the next time period are unlocked for the students to work on only after completion of the evaluation of the core-learning skills for the current time period.

21. The apparatus of claim 15, where the apparatus includes:
a tracking feature for tracking and displaying progress of completing the interdisciplinary project.
